(19) United States
(12) Patent Application Publication
(10) Pub. No.: US 2003/0212688 A1
(43) Pub. Date: Nov. 13, 2003

(54) Stacking and unstacking documents

(76) Inventor: Kristin Smith, Meridian, ID (US)

Correspondence Address: HEWLETT-PACKARD COMPANY, Intellectual Property Administration, P.O. Box 272400, Fort Collins, CO, 80527-2400, US

(21) Appl. No.: 10/141,667

(22) Filed: May 7, 2002

(51) Int. Cl. G06F 7/00

(52) U.S. Cl. 707/100

(57) ABSTRACT

Methods and systems for managing documents stored in a computer system are disclosed herein. The methods and systems comprise selecting a first number of documents to be stacked or unstacked. The selected documents to be stacked or unstacked are converted to a common document format. The selected documents are regrouped into a second number of documents, wherein the second number is different from the first number. Then the second number of documents is renamed.

### TECHNICAL FIELD OF THE INVENTION

The present invention is generally related to the management of documents stored in a computer. More particularly, the present invention is related to systems and methods for stacking and unstacking documents.

### BACKGROUND OF THE INVENTION

Computer users commonly utilize software applications to create and store documents or files. For instance, using graphic software, a user may create and store image documents in a number of graphic file formats such as .bmp, gif, jpg, etc. Using data processing software, a user may create and store text documents in a number of text file formats such as .txt, .doc, etc. Some software applications may use graphic and text software, thereby allowing image documents and text documents to be stored and managed in the same application. For example, the HP LaserJet 3200 is a multi-function printing tool having the capability to print, copy, fax, and scan. The accompanying software for the HP LaserJet 3200, i.e. the Document Manager software application, is used to control the operations of the printing tool and to manage the image and text documents that were created during operation of the printing tool.

In order to allow documents to be managed effectively, computer memory is typically divided into folders and sub-folders in which the documents are stored. Each folder and sub-folder may represent a particular category to help the user organize the documents by keeping related documents together. With this organization of documents, the user can typically manage a large number of documents fairly easily.

However, keeping related documents together may become a problem when the number of documents stored in memory becomes too large. Furthermore, when related documents are stored in memory at different times, the documents may become separated by unrelated documents to a point where it may be difficult for the user to determine which documents are related. Occasionally, users give documents non-descriptive or cryptic filenames, making it difficult to distinguish the contents of documents, and thereby making it difficult to keep related documents together. A user may further complicate matters by storing related documents in different folders or sub-folders. Therefore, it may be beneficial to a user to provide document management tools that simplify and improve the organization of documents by helping the user keep related documents together. Thus, a need exists in the industry to address the aforementioned deficiencies and inadequacies.

### SUMMARY OF THE INVENTION

The present disclosure provides methods and systems for managing documents. One method for managing documents comprises a step of selecting a number of documents. The selected number of documents is then converted to a common format. The method further comprises a step of regrouping the number of documents into a different number of documents, and then renaming the regrouped documents.

In addition, the present disclosure provides embodiments of systems for managing documents, wherein one system comprises means for selecting a first number of documents from a group of documents in a document window and means for initiating a regrouping function. The regrouping function comprises means for converting the first number of documents to a common format, means for assembling the first number of documents into a second number of documents, and means for renaming the second number of documents.

The present disclosure further provides computer programs, which are stored on a medium that can be read by a computer, for managing a number of selected documents. One computer program comprises logic configured to convert the number of selected documents to a common format, logic configured to regroup the number of selected documents into a different number of documents, and logic configured to create a new filename for the different number of regrouped documents.

### BRIEF DESCRIPTION OF THE DRAWINGS

Many aspects of the invention can be better understood with reference to the following drawings. Like reference numerals designate corresponding parts throughout the several views.

FIG. 1 is a block diagram of an embodiment of a computer system having memory in which an example stacker and unstacker are stored.

FIG. 2 is a view of an example embodiment of a main screen shown during execution of an example document management application in which a stacking command and unstacking command operate.

FIG. 3 is a flow chart of an example embodiment of the functionality of stacking and/or unstacking operations.

FIG. 4 is a view of an example embodiment of a main screen illustrating a number of documents in a document window after a stacking operation.

FIG. 5 is a view of an example embodiment of a main screen illustrating a number of documents in a window after an unstacking operation.

### DETAILED DESCRIPTION OF THE INVENTION

Disclosed herein are systems and methods for managing documents accessible to a document management software application. Documents may be managed using a variety of software applications, such as, for example, the Document Manager software application, which is used in conjunction with the HP LaserJet 3200 printing tool. The document management application may include stacking and unstacking operations. Alternatively, the stacking and unstacking operations may be configured as stand-alone applications that operate in parallel with other document management applications.

The present disclosure includes a stacker that performs a stacking operation in which a plurality of documents is combined or “stacked” together to form one document. The documents to be stacked may have the same format or different formats. The term “format” is used herein to refer to the file format or file type, which is typically represented by the three-letter extension at the end of the filename. For example, the file extension “.bmp” represents a document having a bitmap image format. The disclosure further describes an unstacker that performs an unstacking operation in which one document is divided up or “unstacked” in order to form a plurality of documents from the one document.

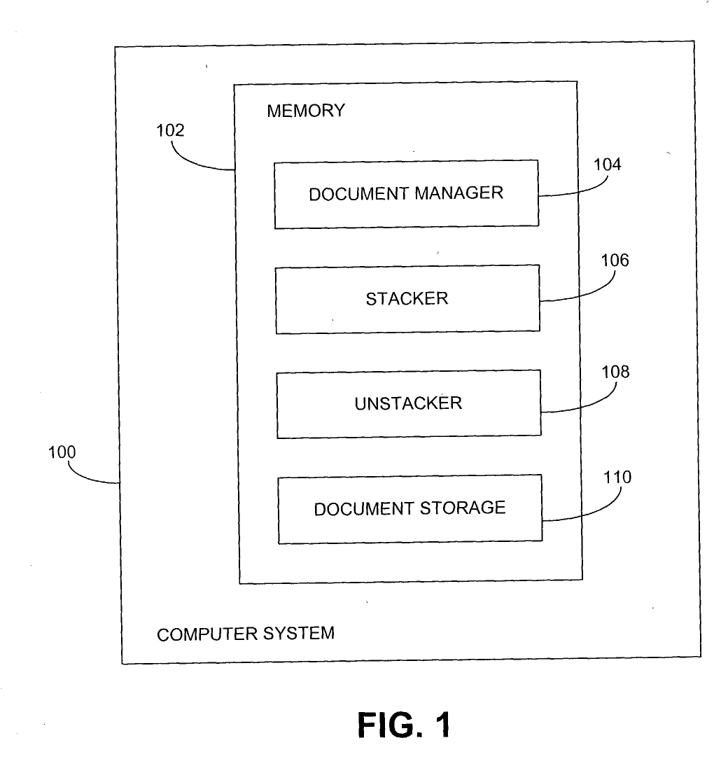

FIG. 1 is a block diagram of a computer system 100, wherein memory 102 is accessible to the computer system 100. The memory 102 can include any one or combination of volatile memory elements (e.g., random access memory (RAM), static RAM (SRAM), dynamic RAM (DRAM), synchronous DRAM (SDRAM), etc.) and nonvolatile memory elements (e.g., read-only memory (ROM), hard drive, tape, compact disk ROM (CDROM), etc.). Moreover, the memory 102 may incorporate electronic, magnetic, optical, and/or other types of storage media. The memory 102 can have a distributed architecture, wherein various components are situated remote from one another, but can be accessed by the computer system 100.

As illustrated in FIG. 1, the memory 102 may comprise at least a document manager 104, a stacker 106, an unstacker 108, and document storage 110. The document manager 104 may be any one of a number of software applications (e.g. Windows Explorer, HP LaserJet Document Manager, etc.) that allows a user to manipulate files or documents stored in document storage 110 by performing such functions as copy, delete, open, rename, find, etc.

The stacker 106 may comprise software capable of grouping a plurality of selected documents into one document. The stacker 106 allows a user to select a number of documents and then converts the selected documents into a common format. For instance, the documents may be converted to a format compatible with text and image documents. Such a format may be beneficial to a user by allowing the user to store image data and text data together. For instance, applications that may utilize both text and image data, e.g. facsimile applications, optical character recognition (OCR) applications, computer aided design (CAD) applications, etc., typically store data in a text layer and an image layer, thereby allowing text and images to be stored together in one application using one format. One example of such a format is the HP Document format, which has the file extension .hpd. It is noted that the file extension is typically indicative of the format. When the documents have been converted to a common format, the stacker 106 “stacks” or combines the selected documents into one document. The stacker 106 either automatically renames the new document or prompts the user to give the stacked document a new filename. The stacking operation allows a user to combine documents that the user considers to be related.

The unstacker 108 performs a function substantially opposite to the function of the stacker 106. Instead of grouping a plurality of documents into one, as is done by the stacker 106, the unstacker 108 divides a single document into multiple documents. Typically, the unstacker 108 allows a user to select one document. The one document may be a document that has previously been stacked or one that has not been stacked. The unstacker 108 converts the document to a format common to the stacking and unstacking operations. For example, the unstacker 108 may convert the document to the HP Document (.hpd) format. Then the unstacker 108 regroups the document into a plurality of documents. The unstacker 108 may regroup the document by dividing the document into separate pages and forming a document for each page. The unstacker 108 may, on the one hand, automatically rename the unstacked documents or, on the other hand, allow the user to rename the unstacked documents.

When the stacker 106 and unstacker 108 are implemented in software, it should be noted that the stacker 106 and unstacker 108 can be stored on any computer-readable medium for use by or in connection with any computer related system or method. In the context of this document, a computer-readable medium is an electronic, magnetic, optical, or other physical device or means that can contain or store a computer program for use by or in connection with a computer related system or method. The stacker 106 and unstacker 108 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. Examples of the computer-readable medium may include the following: an electrical connection having one or more wires, a portable magnetic computer diskette, a random access memory (RAM), a read-only memory (ROM), an erasable programmable read-only memory (EPROM, EEPROM, or Flash memory), an optical fiber, and a portable compact-disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

Although the stacker 106 and unstacker 108 are illustrated in FIG. 1 as being software applications stored in memory 102, the stacker 106 and unstacker 108 may be configured in hardware using circuit components. In such a case, the stacker 106 and unstacker 108 may be located outside the memory 102 while still being accessible to the computer system 100.

The stacker 106 and unstacker 108 of the present disclosure can be implemented in hardware, software, firmware, or a combination thereof. In the disclosed embodiments, the stacking and unstacking operations are implemented in software or firmware that is stored in memory 102 and that is executed by a suitable instruction execution system. If implemented in hardware, as in an alternative embodiment, the stacking and unstacking operations can be implemented with any combination of the following technologies, which are all well known in the art: a discrete logic circuit having logic gates for implementing logic functions upon data signals, an application specific integrated circuit (ASIC) having appropriate combinations of logic gates, a programmable gate array (PGA), a field programmable gate array (FPGA), etc.

The memory 102 further comprises document storage 110. The document storage 110 comprises a storage component that may be capable of storing a plurality of documents. The documents may be any type of document created in or imported into the computer system 100. The document storage 110 may comprise documents that may be categorized as text documents having a text format, image documents having an image format, or text and image documents having a format that is compatible with both text and image documents. The document storage 110 may store documents in folders and any level of nested sub-folders. Typically, the computer system 100 may access the documents grouped in a particular sub-folder at one time.

The memory 102, as illustrated in FIG. 1, is configured such that the document manager 104, stacker 106, unstacker 108, and document storage 110 are separate from each other. In such a configuration, either or both of the stacker 106 and the unstacker 108 may be implemented as stand-alone applications separate from the document manager 104. The stand-alone applications may be stored in the computer system 100 and accessed upon demand. The stand-alone applications may include one or more icons used for initiating the applications. The icons may be placed on a desktop screen of the computer system 100, in the system tray of the computer system 100, on a toolbar of the computer system 100, or on any combination thereof.

Another embodiment, alternative to the stand-alone application embodiment, may include an arrangement wherein the document manager 104 may be configured to incorporate the stacker 106 and the unstacker 108 therein. In such a case, the document manager 104 would be capable of performing the typical document management functions such as accessing documents stored in memory 102, and, additionally, would be capable of performing the stacking of selected documents using the stacker 106 and the unstacking of selected documents using the unstacker 108.

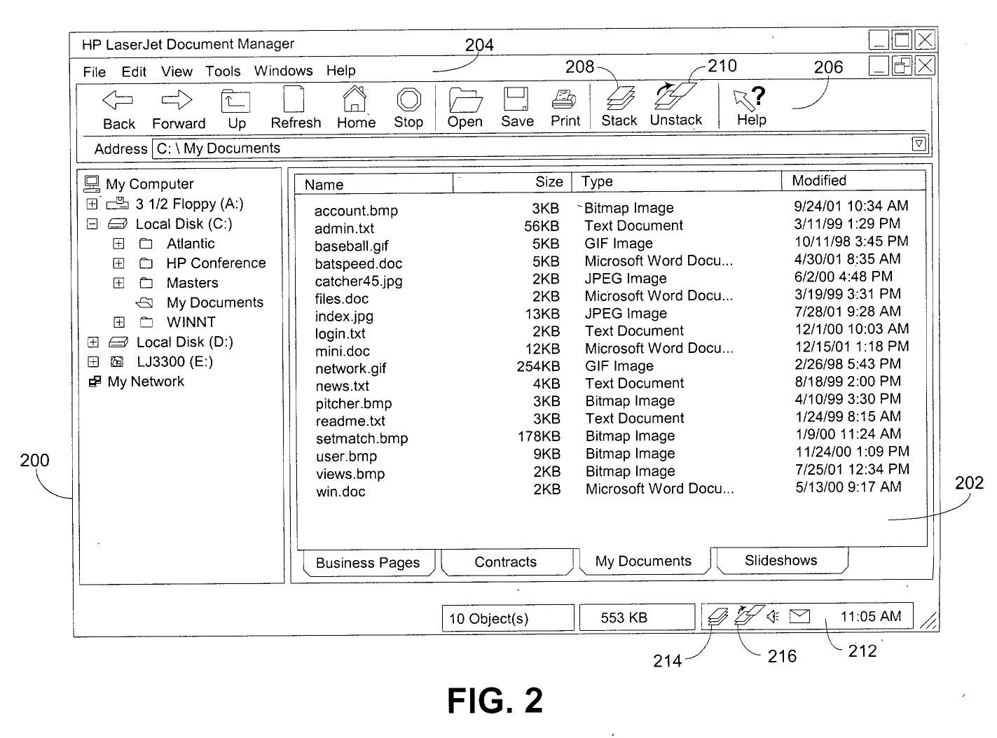

FIG. 2 is a view of an embodiment of a main screen 200 of a display of the computer system 100. The main screen 200 illustrates the document manager 104, e.g., the HP LaserJet Document Manager software application, in operation. The software application may include windows as is shown in FIG. 2. The software application can be the document manager 104 shown in FIG. 1 or any document management application wherein documents are accessed.

The main screen 200 may comprise a document window 202 in which documents filed within a selected folder are displayed. The documents may be displayed in any manner as is well known in the art. For instance, FIG. 2 illustrates an embodiment wherein the documents are displayed in a “Details” format, whereby the name, size, type, and date last modified are shown within the document window 202. It should be noted that “Type” indicates the format of the document. The main screen 200 may further comprise a command toolbar 204 and a standard buttons toolbar 206, allowing a user to perform a variety of functions. One function may be a “Stack” command, accessed by selecting the “Stack” button 208 in the standard buttons toolbar 206. Another function may be an “Unstack” command, accessed by selecting the “Unstack” button 210 in the standard buttons toolbar 206. The selecting of the “Stack” and “Unstack” commands may be accomplished by a user, whereby the user merely clicks on the Stack button 208 or Unstack button 210, respectively. The user may select the commands using any alternative selection mechanism.

The main screen 200 additionally comprises a system tray 212, in which certain software programs can be accessed. In the embodiment described above, wherein the stacker 106 and the unstacker 108 are formed as stand-alone applications, the user may access the Stack command and the Unstack command by respectively selecting the Stack icon 214 and Unstack icon 216, located in the system tray 212.

It should be noted that the documents listed in the document window 202 may comprise documents having various formats. For example, FIG. 2 illustrates an example wherein the documents have different formats, such as bitmap images, text documents, GIF images, Microsoft Word documents, and JPEG images. It should also be noted that documents having any format may be stacked or unstacked according to the principles of the present disclosure.

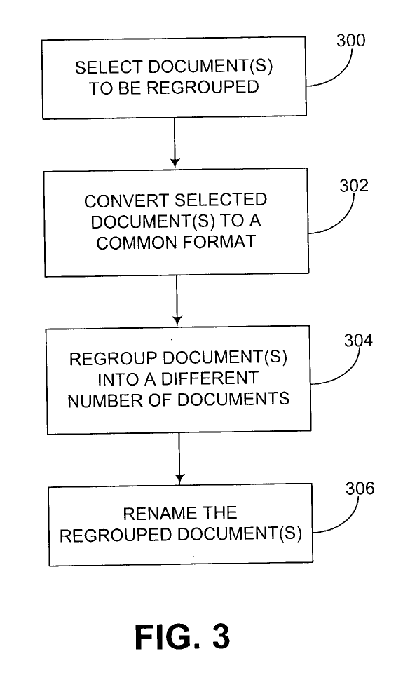

FIG. 3 is a flow chart showing an example method for carrying out either the stacking operation or the unstacking operation. Block 300 of FIG. 3 includes a step of selecting a document or documents that are to be regrouped. In the stacking operation, a plurality of documents is selected. In the typical unstacking operation, one document is selected at a time.

The document selection step (block 300) may be performed automatically based on predefined stacking criteria. For instance, automatic selection may include the selecting of documents having similar filenames, such as when the alphabetic portion of the filenames of multiple documents is the same. In this implementation, documents having names “picture1.bmp,” “picture2.bmp,” and “picture3.bmp,” for example, may be considered as candidates for automatic selection and stacking.

Although the selection of documents (step 300) may be performed automatically, the selection of documents typically involves a user manually selecting documents that the user wishes to regroup. Manual selection may be made using well-known selecting mechanisms. For example, a user may select a plurality of files by moving a mouse pointer over the main screen 200 and clicking on a first document selection. To make another selection, the user may hold down the Ctrl or Shift buttons on a keyboard and click on more document selections. By clicking another selection while holding down the Shift button, the user may select a range of documents from the first selection to the second selection, as is well known. Sporadically positioned documents may be selected by holding the Ctrl button down while clicking on the additional selections.

Although the Unstack command typically involves selecting only one document, the user may select a plurality of documents to be unstacked. Selection of multiple documents for unstacking may be made using the selection techniques mentioned above. When a plurality of documents are selected for unstacking, the unstacker 108 performs the Unstack command for each selected document. In this example, the documents may be unstacked either sequentially or simultaneously, whereby the same process is performed on each document. Although a plurality of documents may be selected for unstacking, the examples used hereinafter refer to a single document being unstacked in order to simplify the description.

In unstacking, the user may select a document that has been stacked or a document that has not been stacked. For the situation where the document has not previously been stacked, the unstacker 108 may comprise circuitry or software to check that the document to be unstacked meets a minimum page limit based on predefined criteria. For example, if the Unstack command unstacks a document into individual pages, then the checking circuitry or software may check that the document to be unstacked is at least two pages in length.

An example of the document-selecting step (block 300) will now be explained with reference back to FIG. 2. First, an assumption is made that the documents baseball.gif, batspeed.doc, catcher45.jpg, and pitcher.bmp, which are shown in the document window 202, are related documents and that the user chooses to stack these documents. The user may click on baseball.gif as the first selected document. By holding down the Shift button, the user may click on catcher45.jpg to select the end of a range from the baseball.gif document to the catcher45.jpg document. Then, the user may hold down the Ctrl button while clicking on the pitcher.bmp document. Typically, the document manager 104 highlights the selected documents to visually indicate to the user which documents have been selected. In this example, the four selected documents are highlighted.

After the document or documents have been selected, the user merely selects either the Stack command, by clicking on the Stack button 208 or the Stack icon 214, or the Unstack command, by clicking on the Unstack button 210 or the Unstack icon 216. The stacker 106 and unstacker 108 may comprise other ways to initiate the Stack and Unstack commands. For example, the user may initiate the commands by opening menu windows (not shown) from the File, Edit, View, or Tools commands from the command toolbar 204 and selecting the Stack or Unstack command from a menu of commands in the opened menu windows. When the user selects the Stack command, the stacker 106 automatically performs the steps indicated in blocks 302, 304, and 306 of FIG. 3. Likewise, when the user selects the Unstack command, the unstacker 108 automatically performs the steps indicated in blocks 302, 304, and 306, as is described below.

The stacking and unstacking operations further comprise a step of converting the selected documents to a common format (block 302). The conversion process may include any technique for converting documents from one format to another. For instance, the stacker 106 or unstacker 108 may utilize the conversion technique defined in co-pending U.S. patent application Ser. No. 09/943,620, filed on Aug. 30, 2001, which is herein incorporated by reference in its entirety.

The converting step may include the converting of the documents to any arbitrary format. It may be desirable that step 302 includes converting the documents to a format that is compatible with text and image documents. It may also be desirable to utilize a common format that includes a “page” concept, wherein each text page and each image is stored as a single page, such that the entire document may have multiple pages. For example, an HP document, having extension .hpd, is a text and image format having text and image layers. Furthermore, the .hpd format uses the page concept for storing text and images.

During the conversion of text documents, the stacker 106 may include circuitry or software that generates images of the pages of text documents, such that an image page is created for each text page. The generated images are stored in the image layer and the original text is stored in the text layer.

Image documents are converted to the common format and stored in the image layer. Many image formats, such as .bmp, .gif, and jpg, for example, do not have the notion of a “page.” Other formats, by definition, create only single-page documents. The converting step (block 302) may accommodate these formats by converting the image or images into multiple pages, thereby conforming to the “page” concept of the common format.

If a document to be converted already contains text and image layers, the document is merely converted to the common format. In such a case, the text data is stored in the text layer of the common format and the image data is stored in the image layer of the common format.

Reference again is made to the example wherein the documents baseball.gif, batspeed.doc, catcher45.jpg, and pitcher.bmp are selected for stacking. In the step indicated by block 302, the example documents are converted to a common format. Since batspeed.doc is the only text document selected, the stacker 106 creates an image document of the text document, stores the image document in the image layer of the common format and stores the original text document in the text layer of the common format. The other selected documents baseball.gif, catcher45.jpg, and pitcher.bmp are image documents and are converted to the common format and stored in the image layer of the common format.

The converting step (block 302) for the unstacking operation involves converting the one selected document to the common format. A text document is stored in the text layer of the common format and an image document is stored in the image layer of the common format. If the one selected document includes both image and text layers, the images created from the original text may be discarded, as long as the original text is saved. Therefore, images of original image data are stored in the image layer of the common format and text of original text data is stored in the text layer of the common format.

When the document or documents have been converted to the common format, the document or documents may then be regrouped into a different number of documents, as indicated in block 304. In the stacking operation, the plurality of documents, which have been selected and converted into the common format, are regrouped or stacked into one document. Thus, the pages of each document are grouped together or stacked so as to form a single document. Preferably, the pages may be stacked in the order in which they were selected during the selecting step (block 300), such that the stacked document contains the pages of the first selected document at the beginning, followed by the pages of the second selected document, and so on. Alternatively, the pages may be stacked in chronological order based on the dates that the selected documents were stored. Other schemes for establishing the order of pages may be used.

It may be desirable to allow a user to stack documents that have related subject matter. For example, if several documents are individually created but are related to the same topic, the user may wish to stack the related documents. This function may be considered as being analogous to stacking related papers on top of a desk.

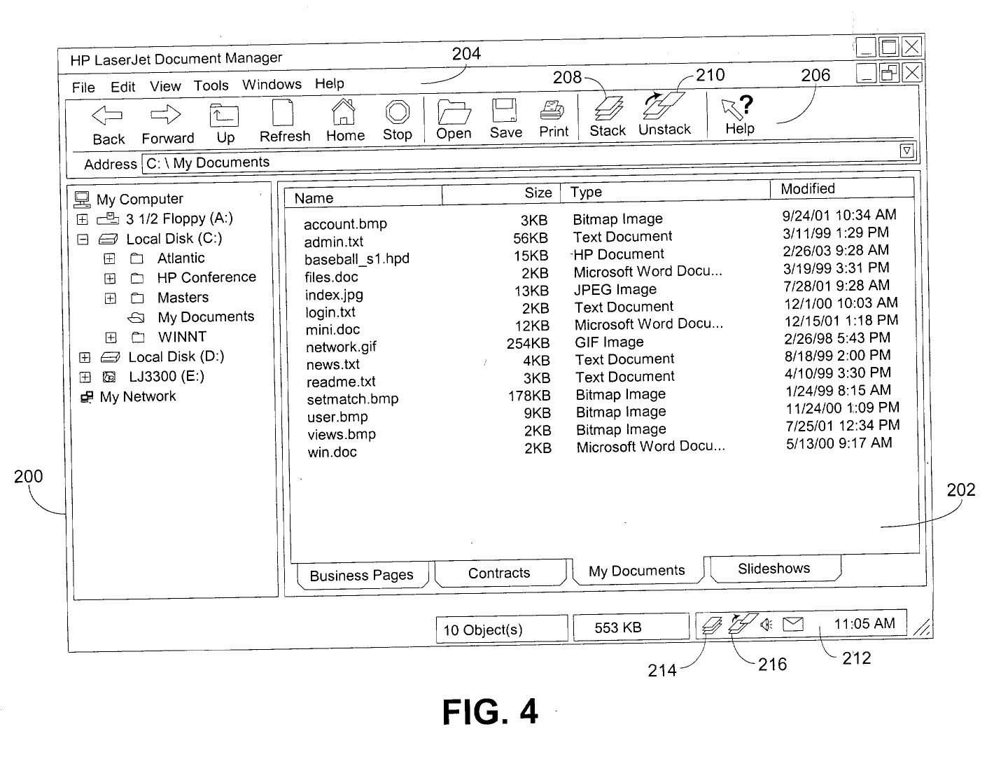

In the above example, the baseball.gif and batspeed .doc documents have a size of 5 KB each. For illustration purposes, it may be assumed that these documents are two pages each. The catcher45.jpg document is 2 KB in size and pitcher.bmp is 3 KB. It may be assumed that these documents are one page each. When stacked together, the documents form one document having six pages and an accumulative size of 15 KB. FIG. 4 illustrates an example main screen 200 wherein the accumulative stacked document “baseball sl.hpd” is shown having a size of 15 KB. It should be noted that the stacked document is shown having the example format “HP Document.”

Referring back to the unstacking method as described with respect to FIG. 3, block 304 refers to the regrouping of the pages of one document into a plurality of documents. For instance, the unstacker 108 may regroup the selected document such that each page of the document becomes a new document. Therefore, if a six-page document is selected for unstacking, each of the six pages is formed into a document, thereby forming six documents.

Block 306 indicates the step of renaming the stacked document. The stacker 106 may use any one or a number of renaming techniques. With respect to the stacking function, the renaming of the stacked document may include automatically adding a “stacking indicator” to the end of the filename of the first selected document. The stacking indicator may be a unique integer appended on the filename to indicate that the newly created document is a stacked document. In the above example, the document baseball.gif was the first selected document. Therefore, the stacker 106 may rename the stacked document “baseball” plus the stacking indicator. For instance, the stacker 106 may rename the stacked document “baseball1.hpd,” wherein the integer “1” indicates that the document is a stacked document. If a later stacking function is performed wherein the baseball.gif document is the first selected document, the stacker 106 may rename the second stacked document “baseball2.hpd.”

Alternatively, the stacker 106 may utilize a different renaming format. For instance, the software application may use an underscore and an integer, e.g. “_{—}1”. Another alternative may include adding the letter “s” to indicate that the document is a stacked document. Using these renaming schemes with the example documents above, the created stacked document may be renamed “baseball_s1.hpd,” as is illustrated in the example in FIG. 4.

Another alternative renaming scheme may include a request for the user's input. A window (not shown) may be opened to request a name for the stacked document and the location where the document will be filed. A default may be set up using one of the automatic renaming schemes mentioned above. Furthermore, another default may be set to place the stacked document into the same folder from which the selected documents were chosen. If documents are selected from different folders, a default may be set for the folder from which the first selected document is selected.

With reference again to block 306 shown in FIG. 3, the renaming step in the Unstack command includes renaming the plurality of newly unstacked documents. As with the Stack command, the Unstack command may also utilize any combination of the automatic renaming techniques mentioned above or may alternatively utilize a manual technique wherein the unstacker 108 prompts the user to rename the documents.

In an example technique for automatically renaming the unstacked documents, the unstacker 108 may append any combination of underscores, alphabetic characters, and integers. For example, the unstacker 108 may append “_{—u}1” to the filename of the document comprising the first unstacked page from the original document. Subsequent integers may be used for subsequent documents, such that the unstacker 108 may append “_u2” to the document comprising the second unstacked page, “_u3” to the document comprising the third unstacked page, “_u4” to the fourth, etc. Alternatively, the unstacker 108 may use other renaming techniques.

After the new filename is established, the stacker 106 and unstacker 108 append a common extension, indicative of the common format. Since the documents are converted to a common format, as explained with respect to block 302, the stacker 106 or unstacker 108 may remove any existing extension and append a new extension to the end of the filename. If step 302 involves converting documents to the “HP Document” format, then the stacker 106 or unstacker 108 appends extension “.hpd”.

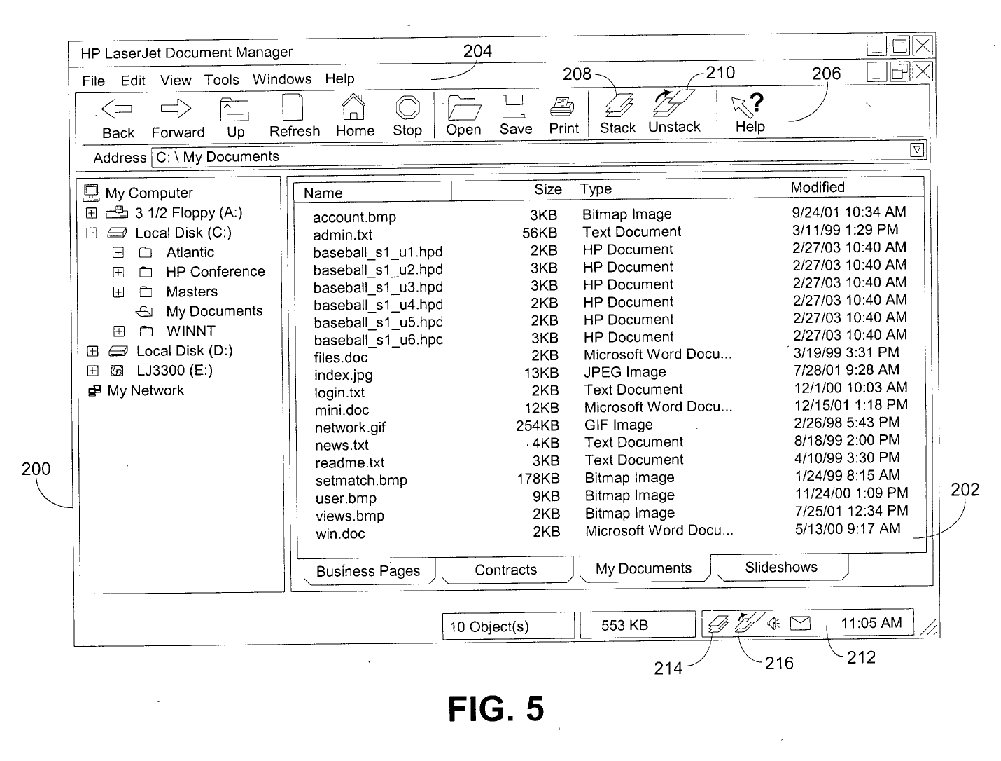

FIG. 5 is a view of an example main screen 200 illustrating the document manager 104 in use and an example of the documents in the document window 202 after the Unstack command. In the above example wherein the stacked document is renamed baseball_s1.hpd, the user may wish to unstack this stacked document. The user selects the baseball_s1.hpd document and then initiates the Unstack command by clicking on the Unstack button 210 in the standard buttons toolbar 206 or the Unstack icon 214 in the system tray 212. In response to the request to perform the Unstack command, the unstacker 108 performs the steps indicated in blocks 302, 304, and 306 of FIG. 3. As shown in FIG. 5, the baseball_s1.hpd document having six pages is regrouped into six documents such that each document comprises one page. Each document is shown having an example size of 2 KB or 3 KB. The unstacked documents are renamed after the selected document, i.e., “baseball_s1” as in this example, plus an unstacking indicator, for example _u1, _u2, _u3, _u4, _u5, and _u6.

The flow chart of FIG. 3 shows the architecture, functionality, and operation of possible implementations of the stacking and unstacking software. The blocks should be understood as representing modules, segments, or portions of code, which comprises one or more executable instructions for implementing the specified logical functions. It should also be noted that in some alternative implementations, the functions noted in the blocks may occur out of the order noted in FIG. 3. For example, blocks 302 and 304 shown in succession in FIG. 3 may in fact be executed substantially concurrently or the blocks may sometimes be executed in the reverse order, depending upon the functionality involved.

It should be emphasized that the above-described embodiments of the present invention are merely examples of possible implementations, set forth for a clear understanding of the principles of the invention. Many variations and modifications may be made to the above-described embodiments of the invention without departing from the principles of the invention. All such modifications and variations are intended to be included herein within the scope of this disclosure and protected by the following claims.

I claim:

1. A method for managing documents, the method comprising the steps of:
selecting a first number of documents;
converting the first number of documents to a common format;
regrouping the first number of documents into a second number of documents, wherein the second number is different from the first number; and
renaming the second number of documents.

2. The method of claim 1, wherein the step of selecting a first number of documents comprises selecting a plurality of documents.

3. The method of claim 2, wherein the step of regrouping comprises regrouping the plurality of documents into one document.

4. The method of claim 1, wherein the step of selecting a first number of documents comprises selecting one document.

5. The method of claim 4, wherein the step of regrouping comprises regrouping the one document into a plurality of documents.

6. A method for stacking documents, the method comprising the steps of:
selecting a plurality of documents;
converting the documents to a common format;
regrouping the documents into one document; and
renaming the one document.

7. The method of claim 6, wherein the step of converting comprises converting the plurality of documents to a format that is compatible with text and image documents.

8. The method of claim 7, wherein the format is an HP Document format having an extension .hpd.

9. The method of claim 7, wherein the text documents have an image layer and a text layer.

10. The method of claim 9, wherein the step of converting further comprises:
creating an image of each page of the text documents; and
storing the images in the image layer.

11. The method of claim 6, wherein the step of renaming comprises:
appending a stacking indicator on a filename of a document selected first during the step of selecting;
removing an existing extension; and
appending an extension indicative of a format compatible with text documents and image documents.

12. The method of claim 11, wherein the stacking indicator comprises at least one of an integer, an underscore, and an alphabetic character.

13. The method of claim 6, wherein the step of renaming comprises requesting an input from a user.

14. A method for unstacking documents, the method comprising the steps of:
selecting one document;
converting the one document to a common format;
regrouping the one document into a plurality of documents; and
renaming the plurality of documents.

15. The method of claim 14, wherein the step of converting comprises the step of converting the one document into a format that is compatible with text and image documents.

16. The method of claim 15, wherein the format is an HP Document format having an extension .hpd.

17. The method of claim 14, wherein the step of regrouping further comprises regrouping each page of the one document into a respective document.

18. The method of claim 14, wherein, for each of the plurality of documents, the step of renaming comprises:
appending a unique unstacking indicator on the name of the one document;
removing an existing extension; and
appending an extension indicative of a format compatible with text documents and image documents.

19. The method of claim 18, wherein each unique unstacking indicator comprises at least one of an integer, an underscore, and an alphabetic character.

20. A system for managing documents, the system comprising:
means for selecting a first number of documents from a document window; and
means for initiating a regrouping function, wherein the regrouping function comprises:
means for converting the first number of documents into a common format;
means for assembling the first number of documents into a second number of documents, wherein the second number is not equal to the first number; and
means for renaming the second number of documents.

21. The system of claim 20, wherein the means for selecting comprise means for selecting a plurality of documents and the means for assembling comprise means for assembling the plurality of documents into one document.

22. The system of claim 21, wherein the means for initiating comprise means for clicking on one of a stacking command from a menu item accessed from a command toolbar, a button on a standard buttons toolbar, and an icon in a system tray.

23. The system of claim 21, wherein the means for converting comprise means for converting the plurality of documents to a format that is compatible with text and image documents.

24. The system of claim 23, wherein the means for converting comprise:
means for creating images representative of the pages of a text document;
means for storing the created images in an image layer of the text document;
means for storing the original text in a text layer of the text document; and
means for storing the original images in an image layer of an image document.

25. The system of claim 20, wherein the means for selecting comprise means for selecting one document and the means for assembling comprises means for dividing the one document into a plurality of documents such that each page of the one document forms a distinct document.

26. The system of claim 25, wherein, for each distinct document, the means for renaming comprise:
means for appending a unique unstacking indicator on the filename of the one document;
means for removing an existing extension; and
means for appending an extension indicative of a format that is compatible with text documents and image documents.

27. A computer program, stored on a computer-readable medium, for managing a number of selected documents, the computer program comprising:
logic configured to convert the number of selected documents into a common format;
logic configured to regroup the number of selected documents into a different number of documents; and
logic configured to create a new filename for each of the different number of regrouped documents.

28. The computer program of claim 27, wherein the number of selected documents comprises at least two documents.

29. The computer program of claim 28, wherein the logic configured to regroup comprises logic configured to regroup the at least two documents into one document.

30. The computer program of claim 28, wherein the number of selected documents comprises one document.

31. The computer program of claim 30, wherein the logic configured to regroup comprises logic configured to regroup the one document into at least two documents.

32. A computer program, stored on a computer-readable medium, for stacking a plurality of selected documents, the computer program comprising:
logic configured to convert the plurality of selected documents to a common format;
logic configured to regroup the documents into a single document; and
logic configured to rename the single document.

33. The computer program of claim 32, wherein the logic configured to convert comprises logic configured to convert the plurality of selected documents to a format that is compatible with text and image documents.

34. The computer program of claim 33, wherein the format is an HP Document format having an extension .hpd.

35. The computer program of claim 33, wherein the text documents have an image layer and a text layer.

36. The computer program of claim 35, wherein the logic configured to convert further comprises:
logic configured to create an image of each page of the text documents; and
logic configured to store the images in the image layer.

37. The computer program of claim 32, wherein the logic configured to rename comprises:
logic configured to append a stacking indicator on a filename of a first-selected document;
logic configured to remove an existing extension; and
logic configured to append an extension indicative of a format compatible with text documents and image documents.

38. The computer program of claim 37, wherein the stacking indicator comprises at least one of an integer, an underscore, and an alphabetic character.

39. The computer program of claim 32, wherein the logic configured to rename comprises logic configured to request an input from a user.

40. A computer program, stored on a computer-readable medium, for unstacking a selected document, the computer program comprising:
logic configured to convert the selected document to a common format;
logic configured to regroup the selected document into a plurality of documents; and
logic configured to rename the plurality of documents.

41. The computer program of claim 40, wherein the logic configured to convert comprises logic configured to convert the selected document into a format that is compatible with text and image documents.

42. The computer program of claim 41, wherein the format is an HP Document format having an extension .hpd.

43. The computer program of claim 40, wherein the logic configured to regroup further comprises logic configured to regroup each page of the one document into a respective document.

44. The computer program of claim 40, wherein, for each of the plurality of documents, the logic configured to rename comprises:
logic configured to append a unique unstacking indicator on the name of the selected document;
logic configured to remove an existing extension; and
logic configured to append an extension indicative of a format compatible with text documents and image documents.

45. The computer program of claim 44, wherein each unique unstacking indicator comprises at least one of an integer, an underscore, and an alphabetic character.
